(19) United States
(12) Patent Application Publication
(10) Pub. No.: US 2022/0198234 A1
(43) Pub. Date: Jun. 23, 2022

(54) TRACKING A COLLECTIVE OF OBJECTS

(71) Applicant: Bayer Aktiengesellschaft, Leverkusen (DE)

(72) Inventor: Johannes DEMMER, Velbert (DE)

(73) Assignee: Bayer Aktiengesellschaft, Leverkusen (DE)

(21) Appl. No.: 17/299,252

(22) PCT Filed: Nov. 27, 2019
(86) PCT No.: PCT/EP2019/082651

§ 371 Date: Feb. 16, 2022

(30) Foreign Application Priority Data
Dec. 3, 2018 (EP) 18209716.2

(51) Int. Cl. G06K 19/07; G06Q 10/08; H04W 4/029

(52) U.S. Cl. CPC G06K 19/0723; H04W 4/029; G06Q 10/0833

(57) ABSTRACT

Please substitute the following paragraph(s) for the abstract now appearing in the currently filed specification:

The present disclosure relates to the tracking of objects. Objects of the present invention are a method, a system and a computer program product for tracking objects.

### CROSS REFERENCE TO RELATED APPLICATIONS

This application is a national stage application under 35 U.S.C. § 371 of International Application No. PCT/EP2019/082651, filed internationally on Nov. 27, 2019, which claims benefit of European Application No. 18209716.2, filed Dec. 3, 2018.

### FIELD OF THE DISCLOSURE

The present disclosure relates to tracking objects. The present invention provides a method, a system and a computer program product for tracking objects.

### BACKGROUND OF THE DISCLOSURE

The tracking and monitoring of objects plays a major role in many areas of the economy. One example is the tracking of goods, in particular pharmaceutical products. Pharmaceutical products are subject to a number of official regulations worldwide. In some countries these include the requirement to guarantee traceability of pharmaceutical products (track & trace). This is done by providing individual pharmaceutical packages with a unique identifier (e.g. a serial number), a process known as serialization, so that they can be uniquely identified at a later date.

The unique identifier is usually printed on the packaging of a goods item as an opto-electronically readable code (barcode, 2D code). At certain points in the supply chain, for instance at shipment, on arrival at a warehouse, when received by a customer or the like, a code of this type is read, and the unique identifier is stored in a database along with information about the current location.

The disadvantage with such a procedure is that the goods item cannot be tracked continuously along the entire supply chain; in fact its location, and if applicable its state, can be ascertained only when the item has reached defined locations at which reading devices are available and the code is read.

It is frequently the case that goods and merchandise get lost in the supply chain. This may be caused, for instance, by accidents or carelessness during transport, handling or storage. Moreover, goods and merchandise can be taken deliberately (theft) or replaced by goods and products in (at least on the outside) equivalent packaging (sabotage or counterfeiting).

There are solutions described in the prior art that address the issue of continuous tracking and safeguarding of goods.

DE202007000597U1 discloses a device for monitoring an object having a transponder. DE10029137A1 discloses a system for locating articles within a cellular mobile communications network. DE102010041548A1 discloses a locating system for determining the position of objects within a locating area by means of a network of active transponders.

A disadvantage of the solutions described in the prior art is that every single object must be equipped with a long-range transmitter in order to be able to track each one continuously. This involves a high level of technical complexity combined with correspondingly high costs.

### SUMMARY OF THE DISCLOSURE

It would also be desirable to be able to detect not only the position of individual objects but also the states that these objects are in.

Proceeding from the prior art, a person skilled in the art is faced with the technical object of providing means which make it possible to track individual objects efficiently and economically, to register any disappearance of objects, and to detect the states that the objects are in.

According to some embodiments, a first subject of the present invention is a system comprising:

a plurality of wireless sensors;

a transceiver;

a server;

an analysis unit; and

position-detection means,

wherein each wireless sensor can be connected to one object each,

wherein each wireless sensor is configured to acquire measured values on the state of the object connected to said sensor, and to transmit state data on the state of the object to the transceiver over a short-range link,

wherein the transceiver is configured
to receive the state data from the wireless sensors;
to transmit the state data to an analysis unit,

wherein the analysis unit is configured
to analyse and compare with each other the items of transmitted state data;
to identify differences in the state data,

wherein the position-detection means are configured to detect the position of the transceiver,

wherein the transceiver is configured to transmit information on the differences and/or on the state data to the server via a long-range link,

wherein the server is configured to display to a user and/or to store in a database, information on the differences and on the position.

According to some embodiments, a further subject of the present invention is a method comprising the steps:

connecting a plurality of objects to one wireless sensor each;

acquiring measured values on states of the objects by means of the wireless sensors connected to the objects;

transmitting state data on the states of the objects to a transceiver over a short-range link;

analysing the state data and comparing the items of state data with each other;

identifying a defined difference in the state data of one wireless sensor from other wireless sensors;

transmitting information on the identified difference and/or the state data to a server via a long-range link;

determining the position of the transceiver;

transmitting the position of the transceiver to the server;

storing the position and the information in a database and/or displaying the position and the information to a user.

According to some embodiments, a further subject of the present invention is a method for associating objects into a collective, comprising the steps:

receiving data during a defined time interval,
wherein the data originates from a plurality of wireless sensors,
wherein the data from each wireless sensor comprises a unique identifier and state data on a state of an object to which the wireless sensor is connected;

comparing the items of state data with each other;

identifying those wireless sensors that indicate identical or corresponding states during the defined time interval;

associating into a collective those objects to which the identified wireless sensors are connected.

According to some embodiments, a further subject of the present invention is a first computer program product comprising program code which is stored on a data carrier and which causes a computer to perform the following steps when the program code is loaded into a main memory of the computer:

receiving data during a defined time interval,
wherein the data originates from a plurality of wireless sensors,
wherein the data from each wireless sensor comprises a unique identifier and state data on a state of an object to which the wireless sensor is connected;

comparing the items of state data with each other;

identifying those wireless sensors that indicate identical or corresponding states during the defined time interval;

associating into a collective those objects to which the identified wireless sensors are connected.

According to some embodiments, a further subject of the present invention is a second computer program product comprising program code which is stored on a data carrier and which causes a computer to perform the following steps when the program code is loaded into a main memory of the computer:

receiving a position of a transceiver;

receiving data,
wherein the data originates from a plurality of wireless sensors,
wherein the data from each wireless sensor comprises a unique identifier and state data on a state of an object to which the wireless sensor is connected;

receiving a list of objects that belong to a collective;

checking against the list and the received data whether state data has been received for all the objects of the collective;

for each object for which state data has been received: adding an entry in a database on the position of the object, wherein the position of the transceiver is entered for the position of the object;

comparing the items of state data with each other;

checking whether the state data of a wireless sensor has a defined difference from the state data of other wireless sensors;

in the event that state data was not received for all the objects, and/or in the event that the state data of a wireless sensor has a defined difference from the state data of other wireless sensors: generating a notification on the missing objects and/or on the difference and communicating the notification to a user.

The invention will be more particularly elucidated below without distinguishing between the subjects of the invention. On the contrary, the following elucidations are intended to apply analogously to all the subjects of the invention, irrespective of in which context they occur.

Where steps in a sequence are mentioned in the present description or in the claims, this does not necessarily mean that the invention is limited to the sequence mentioned. Instead, it is conceivable that the steps can also be executed in a different order or else in parallel to one another, unless one step builds upon another step, which necessarily means that the step building upon the other is executed subsequently (but this will be clear in the individual case). The orders stated are thus preferred embodiments of the invention.

According to some embodiments, the invention is used for monitoring a plurality of objects.

An “object” is a physical (tangible, material) thing. The objects described here are preferably goods. The term “goods” refers to moveable things that are, or may be, the subject of commercial activity. Particularly preferably, objects (goods) are pharmaceutical products (medicines, medicaments, diagnostic items and others).

An object within the meaning of the invention can comprise a plurality of components; an object may be a product in packaging, for example.

The plurality of objects form a collective. The term “plurality” means a number of more than two, preferably more than three. The number of objects that are combined into a collective is typically at least ten and less than one hundred.

The term “collective” means that the objects belonging to a collective are tracked together. Usually, the objects belonging to a collective are transported and stored together. They are usually located on a shared carrier, for instance on a pallet (e.g. a Euro-pallet), in a shared transport box, in a shared container, on a shared trailer, in a shared warehouse and/or the like, and hence form a (loose) grouping.

Each object may be equipped with a wireless sensor. A “sensor” is a technical component which can detect certain physical or chemical properties and/or the material nature of its environment in a qualitative manner, or in a quantitative manner as a measurement variable. The properties are detected by means of physical or chemical effects and transformed into further-processable, usually electrical signals. The electrical signals are usually also digitized before being transmitted by radio to a receiver. A “wireless sensor” is a sensor that has a transmitter unit which can be used to send data by radio.

The transmitter unit may be designed so that it can send data in the form of electromagnetic waves over a short range.

The term “short range” means that the (barrier-free) distance between a transmitter and a receiver must not be greater than a limit in order to ensure error-free transmission of data from the transmitter to the receiver. This limit typically equals 20 metres, although it can also be higher (50 metres maximum) or lower (at least 2 metres).

The term “short-range link” is also used in this description. The term “short-range link” means that a transmitter sends data that is received by a receiver at a distance from the transmitter that is not greater than the aforementioned limit. Error-free reception can no longer be guaranteed if the distance is greater.

It is conceivable that the wireless sensor can also receive data and/or signals over a short-range link.

The wireless sensor is usually connected to the object. The wireless sensor can be adhesively bonded, printed, laminated, clamped, encased or bound onto the object or otherwise connected to the object. It is conceivable that the wireless sensor is irreversibly connected to the object; in this case, any attempt at removal would damage the wireless sensor, making it unusable. It is also conceivable that the wireless sensor is reversibly connected to the object; in this case it can be removed from the object and reused.

The wireless sensor comprises a data storage medium. It is preferably a semiconductor memory. The data storage medium is typically a WORM data storage medium (WORM: write once, read many) Stored in the data storage medium is a unique identifier.

The unique identifier is used to identify the wireless sensor and/or to identify the object to which the wireless sensor is connected. The term “unique identifier” means that the unique identifier can be associated with precisely one wireless sensor; there are no two wireless sensors that have the same identifier.

The unique identifier may be a number or an alphanumeric code or a binary code or a hexadecimal code or the like.

The wireless sensor also comprises an energy supply unit, which supplies the wireless sensor with electrical energy so that it can perform the functions described here.

The energy supply unit may be, for example, an electrochemical cell (battery) or a rechargeable battery. In a preferred embodiment, the energy supply unit is a printable battery such as described, for example, in US2010021799A, EP3104433A1, KR20170085256A, KR20170098004A, US2016351936A and US2010081049A. The wireless sensor can also be designed to extract energy from the environment of the wireless sensor. For example, the energy from the environment can be provided in the form of light, electric fields, magnetic fields, electromagnetic fields, movement, pressure and/or heat and/or other forms of energy, and used by the wireless sensor. Generating electrical energy in this way is known as energy harvesting.

The wireless sensor comprises one sensor or a plurality of sensors, which is/are used to measure a state. Said state may be one or more environmental conditions to which the wireless sensor and/or the object is/was subject (“environmental state”) and/or may be one or more states of the wireless sensor and/or of the object itself (“object state”).

For example, environmental states are a specific value of a temperature, of air pressure, of air humidity, of an intensity of electromagnetic radiation in a specific wavelength range, an accelerating force acting on the sensor, a chemical composition of the surrounding atmosphere (or the presence of one or more specific substances such as, for instance, dry ice or materials for retarding the ripening process) or the like. Environmental states are detected at the point in time and location at which they prevail. If a wireless sensor detects an environmental state at a point in time, then the wireless sensor (and the object) is subject to this environmental state at this point in time.

Object states characterize the object itself. They are in particular environmental states to which the object was exposed at an earlier time; object states can therefore be the result of past environmental conditions. Examples of object states are: the packaging of the object is open or unopened; the object is squashed or not squashed; the object was exposed to a temperature lying above and/or below a defined temperature limit; the object was exposed to a (air) humidity lying above a defined humidity limit; the object was exposed to a pressure lying above and/or below a defined pressure limit; the object was exposed to accelerating forces lying above a defined acceleration limit; and the like. An object state is usually detected using a sensor in which a component is altered (usually irreversibly) by an environmental state above and/or below defined limits. Such a component is also referred to as an indicator in this description. Thus the indicator indicates whether the indicator (and thus also the object to which the indicator is connected) was exposed to a specific environmental state.

In a preferred embodiment, the wireless sensor comprises one or more attitude sensors, which can be used to detect the spatial orientation of the object. For instance, an attitude sensor of this type can be used to detect whether an object is upright or prone (it determines the direction of gravity with respect to one or more geometric features of the object). The one or more attitude sensors can preferably detect a change in the orientation of the object (attitude-change sensor). Both the attitude and changes in attitude can be detected by accelerometers, for example, which are used nowadays in tablet computers, for instance, to detect whether the computer is being held upright or on its side, or which are used in step-counters to count the steps of a person carrying such a step-counter. Usually three accelerometers arranged mutually orthogonally are used to detect accelerations in the three spatial dimensions.

Further preferred states that are detected by the wireless sensor are: temperature, pressure and/or air humidity.

In a preferred embodiment, the wireless sensor comprises a packaging state sensor. The packaging state sensor detects whether packaging containing a goods item is closed or open.

The packaging state sensor detects the packaging state (unopened/open) preferably on the basis of a physical property that changes if the packaging has been opened and/or is being opened. The physical property that changes by the packaging being opened may be, for example, an electrical conductivity (or an electrical resistance) and/or an electrical capacitance and/or an inductance, or the like.

In an embodiment of the present invention, the wireless sensor has one or more electrically conducting wires, which are attached such that at least one wire is irreversibly broken when the packaging (which contains the object or is part of the object) is opened, with the result that an electric current can no longer flow through this wire. The wireless sensor identifies a broken wire from the conductivity having changed. WO9604881A1 or DE19516076A1, for example, describes this principle. In the present case, the wire acts as an indicator; opening the packaging results in an irreversible change in the indicator: breakage of the wire.

States may be detected by the wireless sensor at defined times. A “defined time” means that the time at which a measured value is acquired follows clear rules. For instance, it is conceivable that a measured value is acquired at predetermined times, for example once a day at 12 noon, or every hour on the hour, or every 10 minutes, or the like. A “defined time” shall also be understood to mean, however, the occurrence of a defined event that triggers a measured-value acquisition, for instance an event such as an external (electromagnetic) pulse, vibration, a signal arriving, and the like.

It is conceivable that the measured-value acquisition for detecting a state and the sending of data on the detected state are coupled to each other, for instance in the manner that data on the measured values is sent whenever a measured-value acquisition takes place. A decoupling is also conceivable, however; in this case the wireless sensor comprises a (preferably rewritable) data storage medium in which measured values can be stored (at least temporarily). Measured values can be acquired at defined times and stored in the data storage medium; the stored data can then be sent at other defined times that are independent of the measured-value acquisition times.

It is conceivable that the wireless sensor has a timer. It is also conceivable that a signal from outside (for instance from the transceiver) prompts the wireless sensor to acquire measured values and/or to transfer data at defined times or intermittently.

A (single) transceiver may be assigned to a collective of objects typically for a defined time interval. The defined time interval typically extends across the supply chain of the objects, i.e. an object is typically assigned to a (single) transceiver for as long as the object is in transit and/or in a warehouse until being supplied for its intended use. The assignment is not fixed, however, but can be revoked.

The transceiver has two different wireless radio systems available: a short-range radio system and a long-range radio system.

The transceiver uses the short-range radio system to receive data sent by the wireless sensors over a short-range link. It is also conceivable that the transceiver transmits data and/or signals to the wireless sensors over the short-range link.

The data is transmitted between the wireless sensors and the transceiver via radio i.e. wirelessly using modulated electromagnetic waves in the radiofrequency region. The radio link between a wireless sensor and the transceiver can be implemented, for example, by means of a known standard such as WLAN, Bluetooth, ZigBee, EnOcean, Z-Wave, RFID (ISO18000) or the like. It is also conceivable to use a proprietary protocol.

It is conceivable that the wireless sensors send data independently of one another and independently of the transceiver. The transceiver can be configured such that it “listens” to a defined frequency band, and receives the data sent by wireless sensors in this frequency band.

It is conceivable that instead of establishing an entire radio link, for instance in accordance with the WLAN or Bluetooth standard, for the data transfer, the wireless sensor packages the data for transmission in an advertising data packet, also called a “beacon”.

Devices based on the Bluetooth SIG standard transmit as short range devices (SRD) in an unlicensed ISM band (Industrial, Scientific and Medical band) between 2.402 GHz and 2.480 GHz. Bluetooth Low Energy (Bluetooth LE or BLE for short) is a sub-form of Bluetooth that uses less energy than classical Bluetooth. Bluetooth LE in particular divides the ISM frequency band into 40 channels of width 2 MHz. Bluetooth LE transponders conventionally emit short advertising data packets independently of each other on one of three advertising channels. The advertising channels lie in the ISM frequency band, typically two at the edges of the band and one in the centre of the band. In particular, channels 37, 38 and 39 can be used as the advertising channels on which the advertising signals/data packets are transmitted. Normally, a Bluetooth LE transponder then listens on this channel for a connection request, in response to which a changeover to one of the remaining 37 channels is then made in order to perform data transfer. Thus the advertising channels are broadcast channels that can be used to transfer data packets from a source to all available or “listening” users of the Bluetooth communications network. Advertising data packets can be sent at regular intervals, i.e. periodically, on each advertising channel A time interval between successive advertising data packets can include both a fixed interval and an additional random delay. A standard advertising data packet comprises a maximum payload of 31 bytes for data, which normally specifies the transmitter and its capabilities. This can also be used, however, to transmit any user-defined information to other devices. If the standard 31-byte payload is not large enough for the data, BLE also supports an optional secondary advertising payload. The wireless sensor according to some embodiments of the invention can be configured such that it sends by radio an advertising data packet comprising the data to be transmitted (state data, unique identifier). The transceiver according to some embodiments of the invention can be configured such that it receives the advertising data packet and extracts the at least one item of state information and the unique identifier from the advertising data packet.

As an alternative to the Bluetooth standard, an advertising data packet can also be sent by means of communication based on the Wi-Fi standard (IEEE 802.11). IEEE 802.11 is a family of standards for wireless local area networks (WLAN). According to standard 802.11 from the Institute of Electrical and Electronics Engineers, a service set refers to all the devices in a WLAN. A service set identifier (SSID) is an arbitrary name of a service set that can be used to address this service set. Since this identifier often has to be entered in devices manually by a user, it is usually a character string that people can read easily, and it is therefore referred to generally as the network name of the WLAN. An SSID can be up to 32 bytes long. The wireless sensor according to some embodiments of the invention can be configured such that it sends by radio an SSID data packet comprising the data to be transmitted (state data, unique identifier). The transceiver according to some embodiments of the invention can be configured such that it receives the SSID data packet and extracts the at least one item of state information and the unique identifier from the SSID data packet.

It is also conceivable, however, that the transceiver invokes individual wireless sensors to transmit data. In such a case, a transceiver can use a signal first to prompt the wireless sensors within range of the transceiver to confirm their presence by means of a signal, which typically includes the unique identifier. Then the transceiver connects itself successively to the wireless sensors that are present in order to receive state data.

The transceiver uses the long-range radio system to transmit data (if applicable via one or more intermediate stations) to a separate, usually stationary, computer system (server) over a longer distance. This distance typically equals at least one kilometer.

The data transmission from the transceiver to the separate, usually stationary, computer system (server) takes place (at least in part) likewise by radio, preferably via a mobile communications network, for example via a mobile communications network based on the GSM, GPRS, 3G, LTE, 4G, 5G standard or another standard. Data from the transceiver preferably reaches the Internet via a mobile communications network, and then reaches the server.

The system according to some embodiments of the invention also comprises means for detecting the position of the transceiver. For example, the transceiver can have a sensor (“GPS sensor”) that receives a signal from a satellite navigation system, and determines its position by means of this signal. Known satellite navigation systems are, for example, NAVSTAR GPS, GLONASS, Galileo or Beidou. Since the abbreviation GPS (Global Positioning System) is now used in common speech as the generic term for all satellite navigation systems, the term GPS is used in this description as the collective term for all position-determining systems.

The position of the transceiver can also be derived from the (mobile) communications cell in which the transceiver is located. In mobile communications, the simplest way of determining position is based on the fact that the cell in which a transmitter unit is present is known. Since, for example, a switched-on mobile phone is connected to a base station, the position of the mobile phone can be assigned to at least one mobile communications cell (cell ID). Analogously, the position of the transceiver can equated to the mobile communications cell to which the transceiver is connected. With the aid of GSM (Global System for Mobile Communications), the location of a transmitter unit can be determined to an accuracy of several hundred meters. In towns, the position can be determined to an accuracy of 100 to 500 m; in rural areas, the radius is increased to 10 km or more. If the cell ID information is combined with the TA parameter (TA: Timing Advance), the accuracy can be increased. The higher this value, the greater the distance of the transmitter unit from the base station. It is possible to locate a transmitter unit even more accurately by the EOTD method (EOTD: Enhanced Observed Time Difference). This determines the differences in transit time of the signals between the transmitter unit and multiple receiver units.

The prior art describes further possible ways of determining position (see e.g. DE10029137A1, DE102010041548A1, DE102012214203A1, DE102015121384A1, DE102016225886A1, US2015119086A1).

The system according to some embodiments of the invention can be configured such that the position of the transceiver is detected and transmitted to the server at defined times or at irregular intervals. The server can (actively) request or (passively) receive the position of the transceiver.

The positions of the objects belonging to a collective are equated to the position of the transceiver to which the collective is assigned. Thus there is no need to detect and transmit to the server the position of the objects individually. Instead, just one position (the position of the transceiver) is detected and used for all the objects in the collective. Since the maximum distance at which the objects of a complete collective lie from the transceiver equals the range of the short-range radio link, the positioning error arising for the individual objects as a result of this procedure is negligible. It is even conceivable that this positioning error is less than the accuracy of the methods for determining the position of the transceiver, and is thus irrelevant. The position of all the objects equals (within the described margins of error) the position of the transceiver, however, only when the collective is complete. If an object has been removed, the position of this object (within the described margins of error) does not equal the position of the transceiver. The wireless sensors are used to determine whether the collective is complete. The wireless sensors thereby need neither position-detection means nor means for long-range data transfer (each in the sense given above).

The state data originating from the wireless sensors may be analyzed to determine whether the collective is complete and/or intact. The analysis is conducted by an analysis unit. The analysis unit may be part of the transceiver, although it may also be part of the server. It is also conceivable that some functions of the analysis unit are performed by the transceiver and some functions of the analysis unit are performed by the server.

The analysis unit analyses the state data and checks whether defined limits are/have been satisfied, for instance a maximum temperature, a minimum temperature, a maximum pressure, a minimum pressure, a maximum acceleration, a maximum concentration, a minimum concentration and/or the like.

In particular, the analysis unit compares the items of state data of different wireless sensors with each other in order to identify differences. Differences can indicate whether the collective is complete and/or whether the collective is intact.

The analysis unit can check whether all the wireless sensors have transmitted state data to the transceiver. If the transceiver cannot receive state data from a wireless sensor, this may be because the transceiver is located outside the range of the wireless sensor; it is conceivable that the object to which the wireless sensor is connected has been removed. The collective is no longer complete. The object from which no state data has been received no longer belongs to the collective; its position no longer equals the position of the transceiver belonging to the collective.

The analysis unit can check whether the state data transmitted by the wireless sensors indicates identical or corresponding states or whether there are one or more differences for one or more wireless sensors. If there are one or more differences, the objects are no longer under the same states; the collective is no longer intact. It is conceivable, for example, that an object has fallen off a pallet on which the collective of the objects is being stored. Falling-off means a change in orientation, which is detected by accelerometers, for instance. The remaining objects have not performed the associated change in orientation. Thus there are differences apparent between the state data of the objects: one object has performed movements (falling-off) that differ from the movements made by the remaining members of the collective. The state data need not always indicate absolutely identical states in this context. If an individual object in rectangular packaging is rotated through 90° or 180° about a spatial axis, for instance in order to place it in a more stable position in a stack, such a change in orientation can be irrelevant in terms of checking whether the collective is intact. Unequal states that do not relate to the intactness of the collective are referred to here as corresponding states.

It is also conceivable that the transceiver likewise has one or more sensors that it uses to acquire measured values for states of the environment and/or of the transceiver. This state data can likewise be transmitted to the analysis unit. The state data of the transceiver can be compared with state data of the wireless sensors, and differences can be identified. The state data of the transceiver can be analysed, and the results of the analysis processed further by the server (displaying to a user, storing, generating warning messages when defined limits are crossed and/or the like).

The server displays to a user, for instance on a screen, and/or stores in a database, the position of the transceiver (at different times) and information on the completeness and intactness of the collective.

The grouping of the objects into a collective (forming the collective) can be performed manually or in an automated manner

In this grouping process, the wireless sensors of the objects that belong to the collective are associated with the transceiver. The term association means here a logical association. The result of the association is that the unique identifiers of those wireless sensors that are part of the collective are stored together in a data storage medium of the transceiver and/or of the server (e.g. in a table or another list).

The process of associating wireless sensors with a transceiver can be performed manually by a user, for instance by the user saving a list of unique identifiers of wireless sensors in a data storage medium of the transceiver. The transceiver then communicates only with those wireless sensors whose unique identifiers are stored in the data storage medium, and/or processes only the data that comes from these wireless sensors.

The associating of wireless sensors with a transceiver is preferably performed in an automated manner—during a defined time interval, the transceiver receives state data and unique identifiers from those wireless sensors for which the transceiver is within range. The transceiver stores the unique identifiers together with the accompanying state data in a data storage medium. Then the items of state data of the wireless sensors are compared with each other. Those wireless sensors are identified that indicate identical or corresponding states during the defined time interval. Those wireless sensors that indicate identical or corresponding states during the defined time interval are associated with the transceiver: they form the collective; those wireless sensors that indicate different states during the defined time interval are not associated with the transceiver. Those wireless sensors for which no state data was received during the entire defined time interval are preferably likewise not associated with the transceiver, because they apparently went outside the range of the short-range radio link between wireless sensor and transceiver during the process of forming the collective.

In a preferred embodiment of the present invention, the state which is checked during the above-described association is the orientation and/or changes in orientation of the objects. Only those objects are assigned to the collective that, within the time interval, held the same orientation or performed the same changes in orientation (e.g. caused by unloading).

After the association, the objects form a collective, the completeness and/or intactness of which can be checked, and tracked over time and space by means of the wireless sensors and the transceiver.

The invention, according to some embodiments, is explained below in more detail below with reference to figures, without the intention of restricting the invention to the features and combinations of features shown in the figures.

### BRIEF DESCRIPTION OF THE DRAWINGS

The disclosure will now be described, by way of example only, with reference to the accompanying drawings, in which:

FIG. 1 shows schematically a system according to some embodiments of the invention;

FIG. 2 shows schematically a wireless sensor (F) according to some embodiments of the invention;

FIG. 3 shows schematically a transceiver (S) according to some embodiments of the invention;

FIG. 4 shows schematically a transceiver (S) according to further embodiments of the invention;

FIG. 5 shows schematically an embodiment of the server (C);

FIG. 6 shows a method according to some embodiments of the invention in the form of a flow char;

FIG. 7 shows a method according to further embodiments of the invention in the form of a flow chart;

FIG. 8 shows a method according to further embodiments of the invention in the form of a flow chart;

FIG. 9 shows a method according to further embodiments of the invention in the form of a flow chart; and

FIG. 10 shows a method according to further embodiments of the invention in the form of a flow chart.

### DETAILED DESCRIPTION OF EXEMPLARY EMBODIMENTS

In the Figures Below:

FIG. 1 shows schematically a system according to some embodiments of the invention. The system according to some embodiments of the invention comprises a plurality of wireless sensors (F1, F2, F3, F4, F5) and a transceiver S. The wireless sensors are connected to a plurality of objects (O1, O2, O3, O4, O5); each object carries a wireless sensor. The wireless sensors can transmit data to the transceiver over a short-range link (represented by the dotted lines). The transceiver (S) can transmit data to a server (C) over a long-range link (represented by the dashed line).

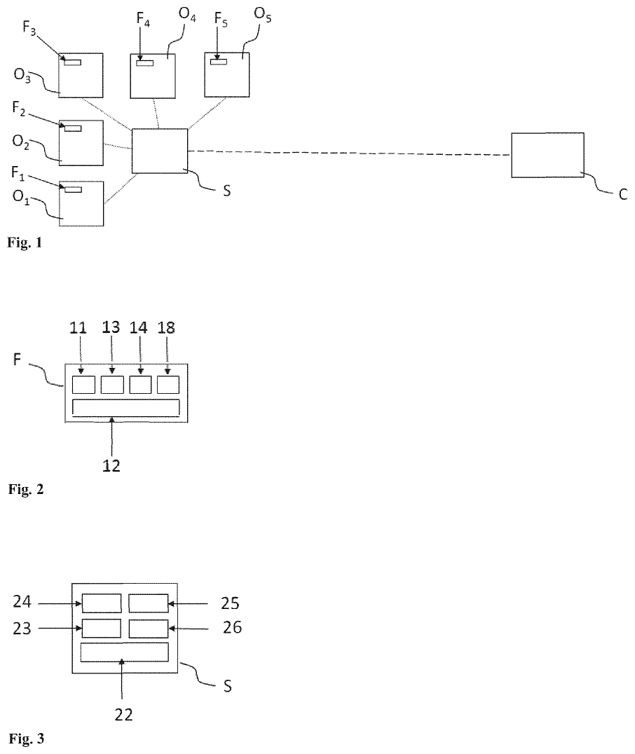

FIG. 2 shows schematically a wireless sensor (F) according to some embodiments of the invention. The wireless sensor (F) comprises at least one sensor (11) for acquiring measured values on a state of the object to which it is connected. The wireless sensor comprises a control unit (12) for controlling the components of the wireless sensor, in particular for controlling the measured-value acquisition and the sending of data to a transceiver. The wireless sensor (F) comprises an energy supply unit (13), a transmitter unit (14) for sending data to the transceiver over a short-range link, and a data storage medium (18), in which a unique identifier is stored. The transmitter unit (14) may also be a unit for sending and receiving data over a short-range link.

FIG. 3 shows schematically a transceiver (S) according to some embodiments of the invention. The transceiver comprises a receiver unit (24) for receiving data sent by a plurality of wireless sensors over a short-range link. The transceiver further comprises an energy supply unit (23), a GPS sensor (25) for position determination, and a transmitter unit (26) for sending data to a server over a long-range link. The transceiver further comprises a control unit (22) for controlling the components of the transceiver, in particular for controlling the receiving of data over the short-range link, for controlling the position determination, and for controlling the sending of data over the long-range link.

The embodiment of a transceiver shown in FIGS. 1 and 3 can be configured such that it receives over a short-range link data from wireless sensors within its range. The data from each of the wireless sensors comprises data on the state of the object to which that wireless sensor is connected, and a unique identifier. The transceiver can use the GPS sensor to establish its position, and can send the data from the wireless sensors together with position data to the server. The server analyses the data. It checks whether state data has been transmitted from all the objects belonging to a collective. If an object is missing, a warning is generated that is communicated to a user. A check is also made for agreement (or correspondence) between the states of the objects for which state data has been transmitted, or for the existence of differences (e.g. in orientation changes, temperature, humidity, packaging state or the like). In the event of differences, a warning is generated that is communicated to a user. In addition, the position information for all the objects for which data has been received is updated: in a database storing information on the position of the objects, the position transmitted by the transceiver is entered as the new position of the objects.

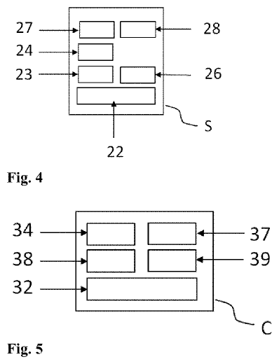

FIG. 4 shows schematically a transceiver (S) according to further embodiments of the invention. In addition to the components described in connection with FIG. 3, the transceiver comprises an analysis unit (27) and a data storage medium (28). A GPS sensor is not present. Unique identifiers of all the wireless sensors whose objects are grouped into a collective can be stored in the data storage medium. The analysis unit is configured to analyse the data from the wireless sensors received by the transceiver: the analysis unit checks against the list of unique identifiers that is stored in the data storage medium as to whether data has been received for all the objects; it compares the states of the objects; it transmits the results of the check to the control unit. If no data has been received for an object, the control unit generates a warning message, and the control unit causes the transmitter unit to transmit the warning message to the server. If there are differences in the states of the objects, the control unit generates a warning message, and the control unit causes the transmitter unit to transmit the warning message to the server. For all objects for which data has been received and which show identical or corresponding states, a notification is generated that they are present and intact. Information about the current position of the transceiver is added to the notification. The position is derived from the mobile communications cell in which the transceiver is currently located.

FIG. 5 shows schematically an embodiment of the server (C). The server (C) comprises a receiver unit (34), by means of which the server (C) can receive data from a transceiver over a long-range link. The data typically comprises state data on the states of objects belonging to a collective, unique identifiers assigned to the objects, and data on the position of the transceiver. The server (C) further comprises a data storage medium (38), in which are stored the unique identifiers and positions of the objects. The server (C) further comprises an analysis unit (37), an output unit (39) and a control unit (32). The control unit (32) is used in particular for controlling the components of the server, for instance the acquisition, analysis and output of data. The data received by the receiver unit (34) is input to the analysis unit (37). The analysis unit checks from the identifiers stored in the data storage medium (38) whether data has been received for all the objects. It compares the states of the objects and identifies differences. If no data has been received for an object, the control unit (32) generates a warning message, and the control unit (32) causes the output unit (39) to display the warning message to a user. If there are differences in the states of the objects, the control unit (32) generates a warning message, and the control unit (32) causes the output unit (39) to display the warning message to a user. For all the objects for which state data has been received, the control unit (32) updates (adds) the positions of the objects, which positions are stored in the data storage medium (38). The position of the transceiver is used as the new (updated) positions of the objects.

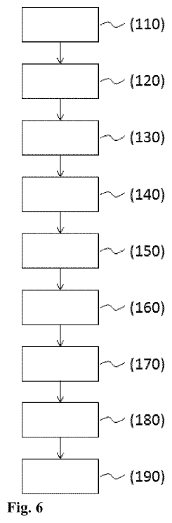

FIG. 6 shows a method according to some embodiments of the invention in the form of a flow chart. The method comprises the steps:
(110) connecting a plurality of objects to one wireless sensor each;
(120) acquiring measured values on states of the objects by means of the wireless sensors connected to the objects;
(130) transmitting state data on the states of the objects to a transceiver over a short-range link;
(140) comparing the items of state data with each other;
(150) identifying a defined difference in the state data of one wireless sensor from other wireless sensors;
(160) transmitting information on the identified difference and/or the state data to a server via a long-range link;
(170) determining the position of the transceiver;
(180) transmitting the position of the transceiver to the server;
(190) storing the position and the information in a database and/or displaying the position and the information to a user.

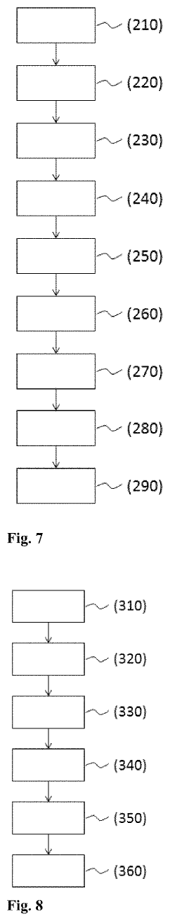

FIG. 7 shows a method according to further embodiments of the invention in the form of a flow chart. The method comprises the steps:
(210) receiving a position of a transceiver;
(220) receiving data,

wherein the data originates from a plurality of wireless sensors,

wherein the data from each wireless sensor comprises a unique identifier and state data on a state of an object to which the wireless sensor is connected;
(230) receiving a list of objects that belong to a collective;
(240) checking against the list and the received data whether state data has been received for all the objects of the collective;
(250) for each object for which state data has been received: updating or adding an entry in a database on the position of the object, wherein the position of the transceiver is entered for the position of the object;
(260) comparing the received items of state data with each other;
(270) checking whether the state data of a wireless sensor has a defined difference from the state data of other wireless sensors;
(280) in the event that state data was not received for all the objects, and/or in the event that the state data of a wireless sensor has a defined difference from the state data of other wireless sensors: generating a notification on the missing objects and/or on the difference and communicating the notification to a user.

FIG. 8 shows a method according to further embodiments of the invention in the form of a flow chart. The method comprises the steps:
(310) receiving data during a defined time interval by means of a transceiver,

wherein the data originates from a plurality of wireless sensors,

wherein the data from each wireless sensor comprises a unique identifier and state data on a state of an object to which the wireless sensor is connected;
(320) comparing the items of state data with each other;
(330) identifying those wireless sensors that indicate identical or corresponding states during the defined time interval;
(340) associating into a collective those objects to which the identified wireless sensors are connected;
(350) determining a position of the transceiver;
(360) updating positions of the objects of the collective in a database by using the position of the transceiver as the updated positions of the objects of the collective.

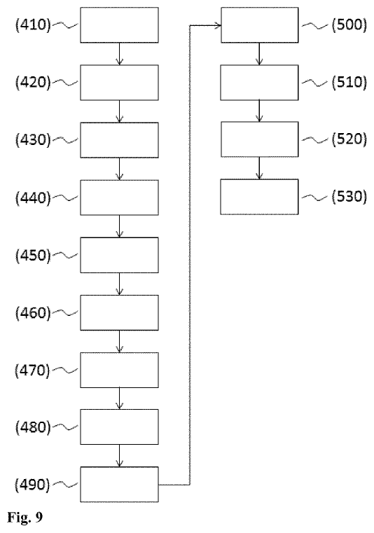

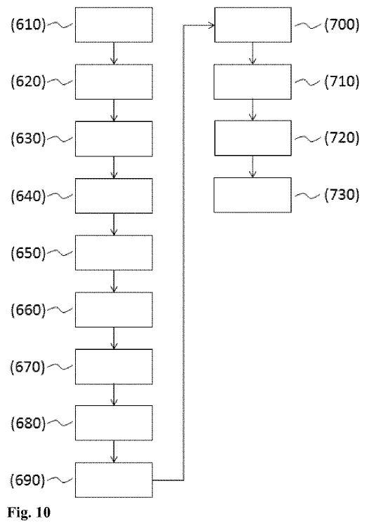

FIG. 9 shows a method according to further embodiments of the invention in the form of a flow chart. The method comprises the steps:
(410) connecting a plurality of objects to one wireless sensor each;
(420) receiving data during a defined time interval by means of a transceiver,

wherein the data originates from the plurality of wireless sensors,

wherein the data from each wireless sensor comprises a unique identifier and state data on a state of the object to which the particular wireless sensor is connected;
(430) comparing the items of state data with each other;
(440) identifying those wireless sensors that indicate identical or corresponding states during the defined time interval;
(450) associating into a collective those objects to which the identified wireless sensors are connected;
(460) acquiring measured values on states of the objects of the collective by means of the wireless sensors connected to the objects;
(470) transmitting state data on the states of the objects of the collective to the transceiver over a short-range link;
(480) comparing the items of state data with each other;
(490) identifying a defined difference in the state data of one wireless sensor from other wireless sensors;
(500) transmitting information on the identified difference and/or the state data to a server via a long-range link;
(510) determining the position of the transceiver;
(520) transmitting the position of the transceiver to the server;
(530) storing the position and the information in a database and/or displaying the position and the information to a user.

FIG. 10 shows a method according to further embodiments of the invention in the form of a flow chart. The method comprises the steps:
(610) connecting a plurality of objects to one wireless sensor each;
(620) receiving data during a defined time interval by means of a transceiver,

wherein the data originates from the plurality of wireless sensors,

wherein the data from each wireless sensor comprises a unique identifier and state data on a state of the object to which the particular wireless sensor is connected;
(630) comparing the items of state data with each other;
(640) identifying those wireless sensors that indicate identical or corresponding states during the defined time interval;
(650) associating into a collective those objects to which the identified wireless sensors are connected;
(660) receiving a position of a transceiver;
(670) receiving data,

wherein the data originates from the plurality of wireless sensors,

wherein the data from each wireless sensor comprises a unique identifier and state data on a state of an object to which the wireless sensor is connected;
(680) receiving a list of objects that belong to the collective;
(690) checking against the list and the received data whether state data has been received for all the objects of the collective;
(700) for each object for which state data has been received: updating an entry in a database on the position of the object, wherein the position of the transceiver is entered for the position of the object;
(710) comparing the received items of state data with each other;
(720) checking whether the state data of a wireless sensor has a defined difference from the state data of other wireless sensors;
(730) in the event that state data was not received for all the objects of the collective, and/or in the event that the state data of a wireless sensor has a defined difference from the state data of other wireless sensors: generating a notification on the missing objects and/or on the difference and communicating the notification to a user.

1. A system comprising:
a plurality of wireless sensors;
a transceiver;
a server;
an analysis unit; and
position detector,
wherein each wireless sensor can be connected to one object each,
wherein each wireless sensor is configured to acquire measured values on a state of the object connected to said sensor, and to transmit state data on the state of the object to the transceiver over a short-range link,
wherein the transceiver is configured:
to receive the state data from the wireless sensors;
to transmit the state data to the analysis unit,
wherein the analysis unit is configured:
to compare with each other items of transmitted state data;
to identify differences in the state data,
wherein the position detector are configured to detect a position of the transceiver,
wherein the transceiver is configured to transmit information on the differences and/or on the state data to the server via a long-range link,
wherein the server is configured to display to a user and/or to store in a database, information on the differences and on the position.

2. The system of claim 1, wherein the position detector is a GPS sensor, which detects the position of the transceiver.

3. The system of claim 1, wherein the position detector is configured to derive the position of the transceiver from a mobile communications cell in which the transceiver is located.

4. The system of claim 1, wherein the wireless sensors are configured to send advertising data packets, which comprise associated unique identifier and associated state data, and wherein the transceiver is configured to receive the advertising data packets and to extract the unique identifiers and the state data from the advertising data packets.

5. The system of claim 1, wherein the state data comprises acceleration data, from which orientations and/or changes in orientation of the objects can be determined.

6. The system of claim 1, wherein the state data can acquire information on a state of packaging containing the objects.

7. A method comprising:
connecting a plurality of objects to one wireless sensor each;
acquiring measured values on states of the objects via the wireless sensors connected to the objects;
transmitting state data on the states of the objects to a transceiver over a short-range link;
comparing items of state data with each other;
identifying a defined difference in the state data of one wireless sensor from other wireless sensors;
transmitting information on the identified difference and/or the state data to a server via a long-range link;
determining a position of the transceiver;
transmitting the position of the transceiver to the server;
storing the position and the information in a database and/or displaying the position and the information to a user.

8. The method of claim 7, comprising:
receiving data during a defined time interval,
wherein the data originates from a plurality of wireless sensors,
wherein the data from each wireless sensor comprises a unique identifier and state data on a state of an object to which the wireless sensor is connected;
comparing the items of state data with each other;
identifying those wireless sensors that indicate identical or corresponding states during the defined time interval;
associating into a collective those objects to which the identified wireless sensors are connected.

9. The method of claim 7, comprising the steps:
receiving data during a defined time interval by the transceiver;
wherein the data originates from a plurality of wireless sensors,
wherein the data from each wireless sensor comprises a unique identifier and state data on a state of an object to which the wireless sensor is connected;
comparing the items of state data with each other;
identifying those wireless sensors that indicate identical or corresponding states during the defined time interval;
associating into a collective those objects to which the identified wireless sensors are connected;
updating or adding positions of the objects of the collective in a database by using the position of the transceiver as the updated positions of the objects of the collective.

10. The method of claim 7, comprising:
receiving data during a defined time interval by the means of a transceiver;
wherein the data originates from the plurality of wireless sensors,
wherein the data from each wireless sensor comprises a unique identifier and state data on a state of the object to which the particular wireless sensor is connected;
comparing the items of state data with each other;
identifying those wireless sensors that indicate identical or corresponding states during the defined time interval;
associating into a collective those objects to which the identified wireless sensors are connected;
receiving the position of a transceiver;
receiving a list of objects that belong to the collective;
checking against the list and the received data whether state data has been received for all the objects of the collective;
for each object for which state data has been received: updating or adding an entry in a database on a position of the object, wherein the position of the transceiver is entered for the position of the object;
comparing the items of state data with each other;
checking whether the state data of a wireless sensor has a defined difference from the state data of other wireless sensors;
in the event that state data was not received for all the objects of the collective, and/or in the event that the state data of a wireless sensor has the defined difference from the state data of other wireless sensors: generating a notification on missing objects and/or on the difference and communicating the notification to a user.

11. A method for associating objects into a collective, comprising:
receiving data during a defined time interval,
wherein the data originates from a plurality of wireless sensors,
wherein the data from each wireless sensor comprises a unique identifier and state data on a state of an object to which the wireless sensor is connected;
comparing items of state data with each other;
identifying those wireless sensors that indicate identical or corresponding states during the defined time interval; and
associating into a collective those objects to which the identified wireless sensors are connected.

12. A non-transitory computer readable medium storing one or more programs, the one or more programs comprising instructions that, when executed by a computer, causes the computer to:
receive data during a defined time interval,
wherein the data originates from a plurality of wireless sensors,
wherein the data from each wireless sensor comprises a unique identifier and state data on a state of an object to which the wireless sensor is connected;
compare the items of state data with each other;
identify those wireless sensors that indicate identical or corresponding states during the defined time interval; and
associate into a collective those objects to which the identified wireless sensors are connected.

13. A non-transitory computer readable medium storing one or more programs, the one or more programs comprising instructions, that when executed by a computer, causes the computer to:
receive a position of a transceiver;
receive data,
wherein the data originates from a plurality of wireless sensors,
wherein the data from each wireless sensor comprises a unique identifier and state data on a state of an object to which the wireless sensor is connected;
receive a list of objects that belong to a collective;
check against the list and the received data whether state data has been received for all the objects of the collective;
for each object for which state data has been received: update or add an entry in a database on the position of the object, wherein the position of the transceiver is entered for the position of the object;
compare items of state data with each other;
check whether the state data of a wireless sensor has a defined difference from the state data of other wireless sensors; and
in the event that state data was not received for all the objects, and/or in the event that the state data of a wireless sensor has the defined difference from the state data of other wireless sensors: generate a notification on missing objects and/or on the difference and communicating the notification to a user.

14. (canceled)
